(19) United States
(12) Patent Application Publication
(10) Pub. No.: US 2024/0419350 A1
(43) Pub. Date: Dec. 19, 2024

(54) CHUNKING AND DEDUPLICATION OF DATA USING ERROR CHECKING VALUES

(71) Applicant: VMware, Inc., Palo Alto, CA (US)

(72) Inventors: Abhay Kumar JAIN, Santa Clara, CA (US); Wenguang WANG, Santa Clara, CA (US); Enning XIANG, San Jose, CA (US)

(21) Appl. No.: 18/334,231

(22) Filed: Jun. 13, 2023

(51) Int. Cl. G06F 3/06; G06F 11/10

(52) U.S. Cl. CPC G06F 3/0641; G06F 3/061; G06F 3/067; G06F 11/1004

(57) ABSTRACT

Chunks of data are identified and deduplication is performed on the chunks of data using associated cyclic redundancy check (CRC) values. A plurality of CRC values is obtained that is associated with consecutive data blocks stored in a payload data store. Cut point CRC values are identified in the plurality of CRC values and CRC chunks are identified based on those cut point CRC values, wherein each CRC chunk is bounded by two consecutive cut point CRC values. A CRC chunk hash value is generated for each CRC chunk. A pair of duplicate CRC chunks is identified using the CRC chunk hash values and a deduplication operation is performed in association with the identified pair of duplicate CRC chunks. Using existing CRC values during the identification of chunk cut points reduces the computing resource costs associated with performing that process using the data blocks.

### BACKGROUND

In a distributed storage system, deduplication processes are used to improve the efficiency of the use of data storage resources. By performing deduplication, duplicated data stored in data storage can be eliminated, freeing the associated data storage space for use in storing other data. To detect duplicate data in data storage, the data is divided into chunks and those chunks are compared for matching or otherwise similar data patterns. Detected duplicate data can then be managed using deduplication processes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for identifying chunks of data and performing deduplication processes on the chunks of data is described. A plurality of cyclic redundancy check (CRC) values is obtained that are associated with a plurality of consecutive data blocks stored in a payload data store. A plurality of cut point CRC values are identified in the plurality of CRC values and CRC chunks are then identified based on those cut point CRC values, wherein each CRC chunk is bounded by two consecutive cut point CRC values. A CRC chunk hash value is generated for each CRC chunk in the plurality of CRC chunks. A pair of duplicate CRC chunks is identified using the CRC chunk hash values and a deduplication operation is performed in association with the identified pair of duplicate CRC chunks.

### BRIEF DESCRIPTION OF THE DRAWINGS

The present description will be better understood from the following detailed description read in light of the accompanying drawings, wherein:

FIG. 1 is a block diagram illustrating an example system that is comprised of a set of compute nodes interconnected with each other and a set of storage nodes;

FIG. 2 is a block diagram illustrating an example system for identifying CRC chunks for use in performing deduplication in a payload data store;

FIG. 3 is a block diagram illustrating example object block data streams that include cut point CRC values and CRC chunks;

FIG. 4 is a flowchart illustrating an example method of identifying duplicate CRC chunks and performing deduplication operations based on the identified duplicate CRC chunks;

FIG. 5 is a flowchart illustrating an example method for identifying cut point CRC values in a plurality of CRC values; and

FIG. 6 illustrates an example computing apparatus as a functional block diagram.

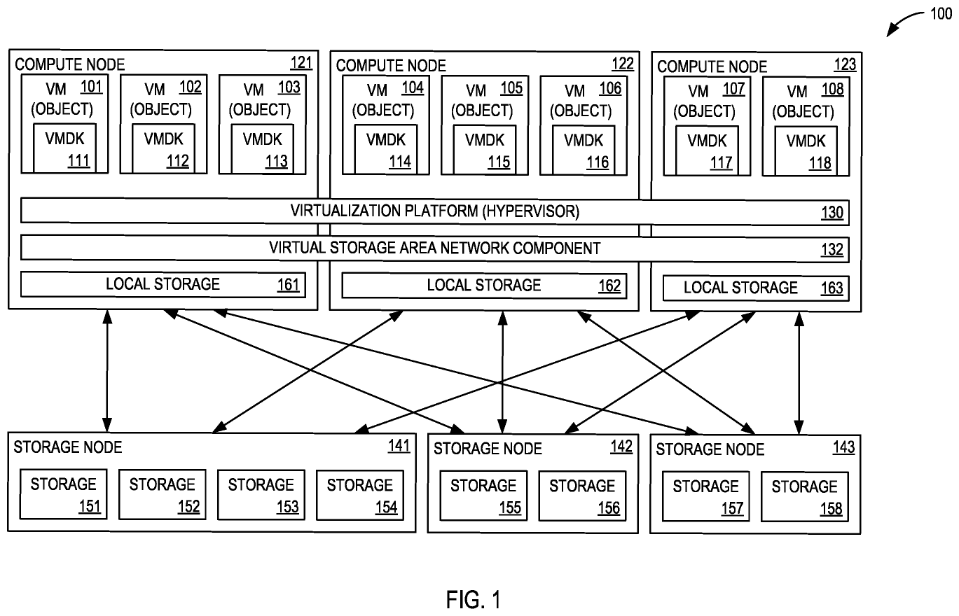

Corresponding reference characters indicate corresponding parts throughout the drawings. In FIGS. 1 to 6, the systems are illustrated as schematic drawings. The drawings may not be to scale. Any of the drawings may be combined into a single example or embodiment.

### DETAILED DESCRIPTION

Aspects of the disclosure provide a computerized method and system for identifying chunks of data and performing deduplication operations on those chunks using associated cyclic redundancy check (CRC) values. In some embodiments, the method obtains a plurality of CRC values from a metadata data store that is associated with a payload data store. The obtained CRC values are associated with a plurality of logically consecutive data blocks, such as those associated with a data object. The CRC values are evaluated to determine which CRC values will be used as cut point CRC values with respect to identified chunks. Cut point CRC values are identified using a cut point indicator, which is a pattern or feature of a subset of the CRC values, such as a pattern of bits that is present in the CRC values. The cut point indicator is used to determine how frequently a cut point CRC value is identified and, as a result, how large is the average data chunk. Additionally, a maximum chunk size may be used to identify some cut point CRC values. The cut point CRC values are used to identify CRC chunks, which are groups of consecutive CRC values that are bounded by two cut point CRC values (or the first or last CRC values in the obtained plurality of CRC values). Further, in some embodiments, the method generates a CRC chunk hash value for each CRC chunk and those hash values are compared to each other to identify duplicate CRC chunks. When a pair or more of duplicate CRC chunks are identified, deduplication operations are performed in association with those duplicate CRC chunks to deduplicate the data blocks in the payload data store associated therewith.

In some embodiments, the method operates in an unconventional manner at least by using existing CRC values associated with payload data blocks to perform operations associated with chunking and deduplicating those payload data blocks. In the described systems, each data block has an associated CRC value that has been generated for use in error checking or the like. Each CRC value is representative of the associated data block but is a much smaller quantity of data. Based on this data size differential, the described cut point identification and data chunking operations can be performed more efficiently with respect to time and resource consumption, such as processing resources, memory resources, or the like, than the equivalent operations being performed with the data blocks themselves.

Further, in some examples, the method uses the CRC data to generate and compare hash values during the identification of duplicate data chunks. As with the chunking operations described above, the generation of hash values from CRC chunk data is more efficient with respect to time and resource consumption than the generation of equivalent hash values from the associated data blocks themselves and, as a result, duplicate CRC chunks can be more efficiently identified. Those duplicate CRC chunks can then be used to identify associated duplicate data block chunks and to perform deduplication operations thereon. Thus, the use of existing CRC values in the described method results in increased computing efficiency and lower computing resource usage (e.g., memory, bandwidth, and processing) throughout the data chunking and deduplication processes than similar processes being performed directly with the associated data blocks.

FIG. 1 is a block diagram illustrating a system 100 that is comprised of a set of compute nodes 121-123 interconnected with each other and a set of storage nodes 141-143 according to an embodiment. In other examples, a different number of compute nodes and storage nodes are used without departing from the description. Each compute node hosts multiple objects, which are virtual machines (VMs), containers, applications, and/or any compute entity that can consume storage, in some examples. When objects are created, they are designated as global or local, and the designation is stored in an attribute. For example, compute node 121 hosts objects 101, 102, and 103; compute node 122 hosts objects 104, 105, and 106; and compute node 123 hosts objects 107 and 108. Some of objects 101-108 are local objects. In some examples, a single compute node hosts 50, 100, or a different number of objects. Each object uses a virtual machine disk (VMDK). For example, VMDKs 111-118 are used by objects 101-108, respectively. Other implementations using different formats are also possible. A virtualization platform 130, which includes hypervisor functionality at one or more of computer nodes 121, 122, and 123, manages objects 101-108.

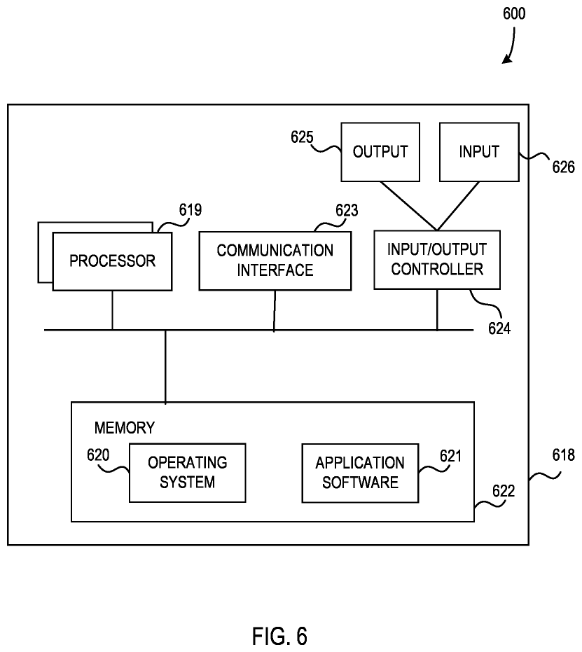

In some examples, various components of system 100, for example compute nodes 121, 122, and 123, and storage nodes 141, 142, and 143 are implemented using one or more computing apparatuses 618 of FIG. 6.

Virtualization software provides software-defined storage (SDS) by pooling storage nodes across a cluster, creates a distributed, shared data store (e.g., a storage area network (SAN)). In some examples with distributed arrangements, servers are distinguished as compute nodes (e.g., compute nodes 121, 122, and 123) and storage nodes (e.g., storage nodes 141, 142, and 143). In such examples, storage nodes attach large quantities of storage devices (e.g., flash, solid state drives (SSDs) and non-volatile memory express (NVMe) and Persistent Memory (PMEM)) processing power are limited beyond the ability to handle input/output (I/O) traffic. For example, storage node 141 has storage 151, 152, 153, and 154; storage node 142 has storage 155 and 156; and storage node 143 has storage 157 and 158. In other examples, a single storage node includes a different number of physical storage components without departing from the description. In the described examples, storage nodes 141-143 are treated as a SAN with a single global object, enabling any of objects 101-108 to write to and read from any of storage 151-158 using a virtual SAN component 132. Virtual SAN component 132 executes in compute nodes 121-123.

In some examples, thin provisioning is used and storage nodes 141-143 do not require significantly more processing power than is needed for handling I/O traffic. This arrangement is less expensive than many alternative hyperconverged environments in which all of storage nodes 141-143 have the same or similar processing capability as compute node 121. Using aspects of the disclosure, compute nodes 121-123 can operate with a wide range of storage options.

In some examples, compute nodes 121-123 each include a manifestation of virtualization platform 130 and virtual SAN component 132. Virtualization platform 130 manages the generating, operations, and clean-up of objects 101 and 102, including the moving of object 101 from compute node 121 to another compute node, to become a moved object. For example, virtual SAN component 132 permits objects 101 and 102 to write incoming data from object 101 and incoming data from object 102 to storage nodes 141, 142, and/or 143, in part, by virtualizing the physical storage components of the storage nodes. Further, in some examples, the compute nodes 121, 122, and 123 include and make use of local storage nodes 161, 162, and 163, respectively, for storing some data used during the operation of the system 100 without departing from the description.

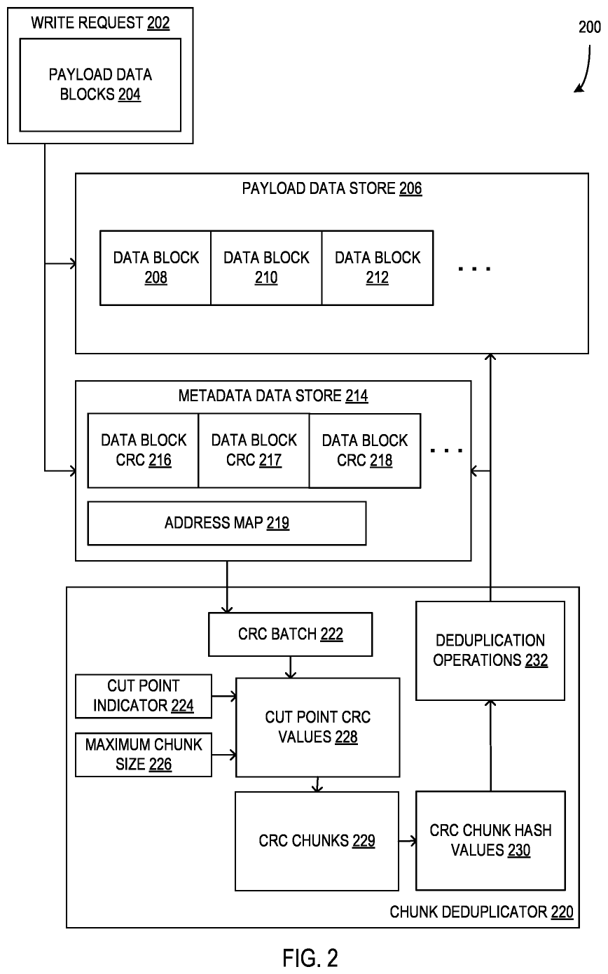

FIG. 2 is a block diagram illustrating an example system 200 for identifying cyclic redundance check (CRC) chunks 229 for use in performing deduplication in a payload data store 206. In some examples, the system 200 is part of or otherwise associated with a system such as system 100 of FIG. 1. For example, the payload data store 206 and metadata store 214 are part of a storage node such as storage node 141 and the chunk deduplicator 220 operates as described herein to deduplicate data blocks in the payload data store 206.

The system 200 includes a payload data store 206 and an associated metadata store 214. The payload data store 206 is configured to store payload data in a series or group of data blocks such as data blocks 208, 210, and 212. In some examples, the payload data store 206 is configured as a log-structured data store, but in other examples, the payload data store 206 is configured as a different type of data store without departing from the description.

In some examples, the metadata data store 214 is configured to store data block CRCs 216, 217, and 218 that are associated with the data blocks 208-212 of the payload data store 206. Further, the metadata data store 214 includes an address map 219 that is configured to map at least logical block addresses (LBAs) of data in the logical data space of the system to physical block addresses (PBAs) of the data blocks 208-212 on the payload data store 206. Additionally, in some examples, the address map 219 includes two maps that enable the use of a middle address space and associated middle block addresses (MBAs) as an additional layer of abstraction between the LBAs of the logical address space and the PBAs of the physical address space. For example, the address map 219 includes a first map that maps LBAs to MBAs and a second map that maps MBAs to PBAs, such that identifying a PBA with which an LBA is associated includes identifying an MBA associated with the LBA and then identifying a PBA associated with the identified MBA.

Further, in some examples, the address map 219 and/or other associated metadata, such as the data block CRCs 216-218, are arranged in tree data structures, such as B-tree data structures, which enable more efficient access to the metadata therein. For example, metadata store 214 includes one or more tree data structures that include nodes associated with the data blocks 208-212 and the data block CRCs 216-218 are stored in or with the nodes of the data blocks 208-212 from which the data block CRCs 216-218 have been generated. For example, the data block CRC 216 is generated from the data block 208 and the metadata associated with the data block 208 is stored in a node of a tree structure in the metadata data store 214. The metadata stored in the node of the data block 208 includes the data block CRC 216 and/or address mappings as described herein, such that the metadata associated with the data block 208 can be accessed by traversing the tree data structure.

It should be understood that the data block CRCs 216-218 are data values that are used as error-detecting codes and that a data block CRC 216-218 is generated for each data block 208-212 written to the payload data store 206. In some examples, a write request 202 is received that includes payload data blocks 204 that are to be written to the payload data store 206. For each of the payload data blocks 204, a data block CRC is generated and stored in the metadata store 214 in association with other metadata of the particular data block. The data block CRCs 216-218 are then used to detect errors associated with data transmission within the system 200 and/or to otherwise validate the data blocks 208-212 as they are stored in the payload data store 206.

The chunk deduplicator 220 includes hardware, firmware, and/or software configured to use the data block CRCs 216-218 to determine or define CRC chunks 229, to identify duplicate chunks within the CRC chunks 229, and to perform deduplication operations 232 or otherwise cause deduplication operations 232 to be performed. In some examples, the deduplication process performed by the chunk deduplicator 220 is performed periodically and/or in parallel with other operations of the system 200, such as receiving write requests 202 and writing associated data to the payload data store 206 and/or the metadata data store 214. Further, in some examples, the CRC chunks 229 are identified using “content-defined chunking” (CDC), which is useful for dividing large quantities of data into chunks while enabling the identification of duplicate portions of data even if the data is shifted or slightly modified.

The chunk deduplicator 220 obtains a CRC batch 222 from the metadata data store 214. The CRC batch 222 includes a series of CRCs (e.g., data block CRCs 216-218) that are associated with a series of data blocks 208-212 in the payload data store 206. In some examples, the order of the CRCs in the CRC batch 222 reflects an order of the associated data blocks 208-212 in the payload data store 206. For example, the first CRC of the CRC batch 222 is associated with a first data block and the second CRC in the CRC batch 222 is associated with a second data block that is located after the first data block in the payload data store 206.

The chunk deduplicator 220 uses a cut point indicator 224 and/or a maximum chunk size 226 to identify or otherwise determine cut point CRC values 228. In some examples, the cut point indicator 224 includes a pattern or other feature of a subset of the CRCs in the CRC batch 222 that is pre-defined. For example, the cut point indicator 224 is present in CRCs with zeros in the four least significant bits (e.g., a CRC value of 0xA0). This cut point indicator 224 results in approximately 1/16^{th} of the CRCs in the CRC batch 222 being identified as cut point CRC values 228. In other examples, other features or patterns are used as a cut point indicator 224 without departing from the description (e.g., CRCs with zeros in the three least significant bits results in twice as many cut point CRC values 228 and CRC chunks 229 that are approximately half as large as those in the previous example). Further, in still other examples, more, fewer, and/or different quantities of bits and/or different patterns of bits are used as cut point indicators 224 as described herein without departing from the description.

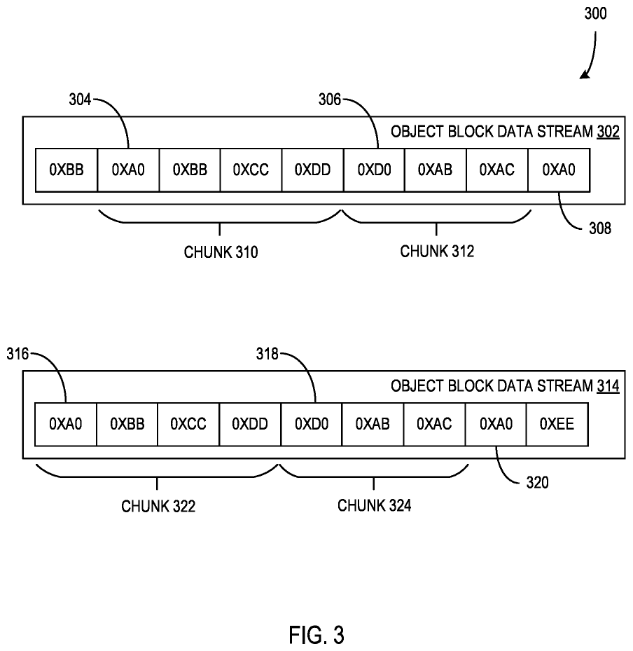

Further, in some examples, the chunk deduplicator 220 scans or otherwise reads each of the CRCs in the CRC batch 222 to determine whether each CRC includes a feature or pattern that matches the cut point indicator 224. The CRCs of the CRC batch 222 are read and evaluated in order. Thus, the first cut point CRC value 228 is the first CRC in the CRC batch 222 that includes a feature or pattern that matches the cut point indicator 224. The identification of cut point CRC values 228 is described further below at least with respect to FIG. 3.

Additionally, in some examples, a maximum chunk size 226 is defined and used to identify or otherwise determine cut point CRC values 228. As the chunk deduplicator 220 reads each CRC in the CRC batch 222 in order to identify features or patterns that match the cut point indicator 224, it counts the number of CRCs that have been read since reading the first CRC of the CRC batch 222 or since reading the last identified cut point CRC value 228, whichever happened more recently. In some examples, the maximum chunk size 226 is defined as a quantity of CRCs. When the count of the number of CRCs that have been read by the chunk deduplicator 220 since the last cut point reaches the maximum chunk size 226, the chunk deduplicator 220 determines that the current CRC being evaluated is a cut point CRC value 228, regardless of whether the current CRC has the features and/or patterns that match the cut point indicator 224. For example, the maximum chunk size 226 is set to 20, such that, after the chunk deduplicator 220 has read and evaluated 20 CRCs since the beginning of the CRC batch 222 or since the last cut point CRC value 228 was identified, the current CRC is determined to be a cut point CRC value 228.

In some examples, the maximum chunk size 226 is defined in the form of a quantity of memory (e.g., 64 kilobytes (KB) of memory). In such examples, the chunk deduplicator 220 and/or the system 200 generally stores a data size value of the data blocks 208-212 (e.g., each data block is 4 KB). Because each CRC of the CRC batch 222 is associated with a data block, a maximum chunk size 226 that is defined as a quantity of memory is divided by the data size value of the data blocks 208-212 to determine the maximum quantity of CRCs that the chunk deduplicator 220 reads prior to determining that a CRC is a cut point CRC value 228 based on the maximum chunk size 226. For instance, in an example, the maximum chunk size 226 is defined as 64 KB and the data size value of the data blocks 208-212 is defined as 4 KB. Thus, the quantity of CRCs that the chunk deduplicator 220 counts prior to determining that a current CRC is a cut point CRC value 228 based on the maximum chunk size 226 is 16 CRCs (64 KB divided by 4 KB is 16 data blocks and 16 associated CRCs).

The chunk deduplicator 220 uses the cut point CRC values 228 to identify or otherwise determine CRC chunks 229. A CRC chunk 229 is a plurality of consecutive or sequential CRCs from the CRC batch 222. The boundaries of each CRC chunk 229 are either the first CRC in the CRC batch 222, the last CRC in the CRC batch 222, and/or a cut point CRC value 228. For instance, the first CRC chunk 229 of the CRC batch 222 starts with the first CRC of the CRC batch 222 and ends with the first identified cut point CRC value 228. In some examples, the first CRC chunk 229 includes the first cut point CRC value 228 but in other examples, the first CRC chunk 229 ends with the CRC before the first cut point CRC value 228 and the first cut point CRC value 228 is the first CRC of the next CRC chunk 229. Whether the first cut point CRC value 228 is included as the end of the first CRC chunk 229 or as the beginning of the second CRC chunk 229, the pattern is maintained for all CRC chunks 229 (e.g., a cut point CRC value 228 is always the last or first CRC in the CRC chunks 229, respectively).

It should be understood that a CRC chunk 229 is a series of CRCs that are associated with a series of data blocks 208-212 of the payload data store 206. Thus, a CRC chunk 229 is representative of a chunk of consecutive data blocks 208-212. In some examples, the consecutive data blocks 208-212 are consecutive with respect to the logical address space, such that LBAs of the data blocks 208-212 are in consecutive order while the physical locations of the data blocks 208-212 within the payload data store 206 may not be consecutive. The CRC chunks 229 can be used in the performance of data processing operations on the associated chunks of consecutive data blocks 208-212, such as the deduplication operations 232 as described herein.

The chunk deduplicator 220 is configured to perform a hash function on each of the CRC chunks 229 to generate a CRC chunk hash value 230 for each CRC chunk 229. A hash function is a function that can be used to map data of an arbitrary size to a fixed-size value. In the described example, the input data for the hash function is the group of CRC values of a CRC chunk 229 and the output is a CRC chunk hash value 230. While the CRC chunk hash values 230 are likely to be far smaller in size than the combined CRC values of the CRC chunks 229, a type of hash function is used that makes it very unlikely that two different CRC chunks 229 produce matching CRC chunk hash values 230. However, when two or more CRC chunks 229 are duplicates of each other, the generated CRC chunk hash values 230 of those CRC chunks 229 match.

It should be understood that comparison of CRC chunk hash values 230 with each other is much more resource cost effective (e.g., in terms of system resources and time) than direct comparison of the CRC chunks 229 themselves. Thus, while it would be possible for the chunk deduplicator 220 to identify duplicate CRC chunks 229 using direct comparisons of the CRC chunks 229, it is more technically efficient to generate the CRC chunk hash values 230 and then compare those hash values 230 in most examples.

In some examples, the CRC chunk hash values 230 are used to configure, initiate, and/or perform deduplication operations 232 on data stored in the payload data store 206 and associated metadata in the metadata data store 214. For example, when matching CRC chunk hash values 230 are identified, the associated chunks of data blocks 208-212 are identified as duplicate data block chunks. To enhance the technical efficiency of the storage space of the payload data store 206, one data block chunk is deleted or otherwise removed from the payload data store 206 while the other data block chunk is used. In some of such examples, the data block chunk that is to be removed due to deduplication operations 232 is dereferenced and then freed and/or flagged for removal by another process. In addition to the operations performed on the payload data store 206 to remove all but one instance of a set of duplicate data block chunks, the deduplication operations 232 also update the metadata associated with those duplicate data block chunks in the metadata data store 214. For instance, the address map 219 is updated by changing all the mappings that are directed to data block chunks that will be removed to be directed to the one instance of the duplicate data block chunks that is being preserved. In other examples, other metadata changes are also made to the metadata data store 214 without departing from the description.

Further, in some examples, the CRC chunk hash values 230 are used to identify possible duplicate data block chunks and to enable the system 200 to perform additional analysis to determine whether the identified data block chunks are duplicates. In such examples, CRC chunks 229 that are found to be duplicates using the CRC chunk hash values 230 are used to identify the associated data block chunks of those CRC chunks 229. Then, cryptographic hash values are generated for each of the data block chunks and those cryptographic hash values are compared to each other. If the cryptographic hash values match, then the data block chunks are found to be duplicates and deduplication operations 232 are performed. Alternatively, if the cryptographic hash values do not match, then the data block chunks are found to not be duplicates and the deduplication operations 232 are not performed.

In some examples, the identification of cut point CRC values is performed by a cut point identifier of a chunk deduplicator (e.g., chunk deduplicator 220). The cut point identifier includes hardware, firmware, and/or software configured to identify cut points based on cut point indicators as described herein.

In some examples, the generation of CRC chunk hash values is performed by a hash value generator of a chunk deduplicator (e.g., chunk deduplicator 220). The hash value generator includes hardware, firmware, and/or software configured to generate hash values from a plurality of CRC values using a hash function as described herein.

In some examples, the identification of duplicate CRC chunks is performed by a duplicate chunk identifier of a chunk deduplicator (e.g., chunk deduplicator 220). The duplicate chunk identifier includes hardware, firmware, and/or software configured to identify pairs of duplicate chunks as described herein (e.g., using cryptographic hash values).

It should be understood that, while many examples described herein use CRC values 216-218 to determine the chunk boundaries and to deduplicate the identified chunks as described herein, in other examples, other data values and/or metadata values associated with the data blocks 208-212 are used in place of the CRC values 216-218. For instance, in some examples, other types of error checking codes or error checking values, such as checksum values, forward error correction (FEC) values, other hash values, parity check values, Reed-Solomon codes, or the like, are used in place the CRC values as described herein. In such examples, the cut point indicator 224 is defined to fit the data patterns of the type of data values being used in place of the CRC values, such that a desired percentage of the data values are found to be cut point values (e.g., cut point CRC values 228). Similarly, the data values being used are divided into chunks like the CRC chunks 229 and chunk hash values like the CRC chunk hash value 230 are generated as described herein. In other examples, other types of data values associated with the data blocks 208-212 are used in place of the CRC values 216-218 without departing from the description (e.g., metadata values that are stored for each data block in the metadata data store 214). In some such examples, a metadata value used in place of the CRC values 216-218 is significantly smaller than the size of the data blocks themselves and has at least one possible data pattern that occurs at a probability rate that enables the data pattern to be used as a cut point indicator 224 as described herein.

FIG. 3 is a block diagram 300 illustrating example object block data streams 302 and 314 that include cut point CRC values 304, 306, 308, 316, 318, and 320 and CRC chunks 310, 312, 322, and 324. In some examples, the object block data streams 302 and/or 314 are analyzed and processed in a system such as system 200 of FIG. 2. For instance, in an example, the CRCs of the object block data streams 302 and/or 314 are provided to the chunk deduplicator 220 which then identified cut point CRC values and associated CRC chunks therein.

The cut point indicator 224 used with the object block data streams 302 and 314 is a pattern of zeroes in the four least significant bits of the CRCs. CRC 304 has a value of 0xA0, which indicates that the four least significant bits of the CRC are zero. Thus, CRC 304 is identified as a cut point. Similarly, CRCs 306 and 308 are identified as cut points in the object block data stream 302. CRCs 316, 318, and 320 are identified as cut points in the object block data stream 314 in the same way.

Each identified cut point CRC value 228 is used as a first CRC in a CRC chunk 229. So, the CRC chunk 310 is defined as the group of CRCs starting with the CRC 304 and ending with the CRC immediately before CRC 306. The CRC chunk 312 is defined as the group of CRCs starting with the CRC 306 and ending with the CRC immediately before CRC 308. In the other object block data stream 314, the CRC chunk 322 is defined as the group of CRCs beginning with the CRC 316 and ending with the CRC immediately before the CRC 318. The CRC chunk 324 is defined as the group of CRCs beginning with the CRC 318 and ending with the CRC immediately before the CRC 320. As illustrated, the CRC chunks 310, 312, 322, and 324 are not necessarily the same size (e.g., chunk 310 has four CRCs and chunk 312 has three CRCs).

After identification of the CRC chunks 310, 312, 322, and 324, hash values of the chunks are generated and compared as described herein. In the illustrated example, the hash values of the chunks 310 and 322 and of the chunks 312 and 324 would match each other, respectively. Thus, CRC chunk 310 and CRC chunk 322 are identified as duplicate chunks and CRC chunk 312 and CRC chunk 324 are identified as duplicate chunks. In some such examples, deduplication operations 232 are performed to remove one instance of each of the pairs of duplicate chunks as described herein.

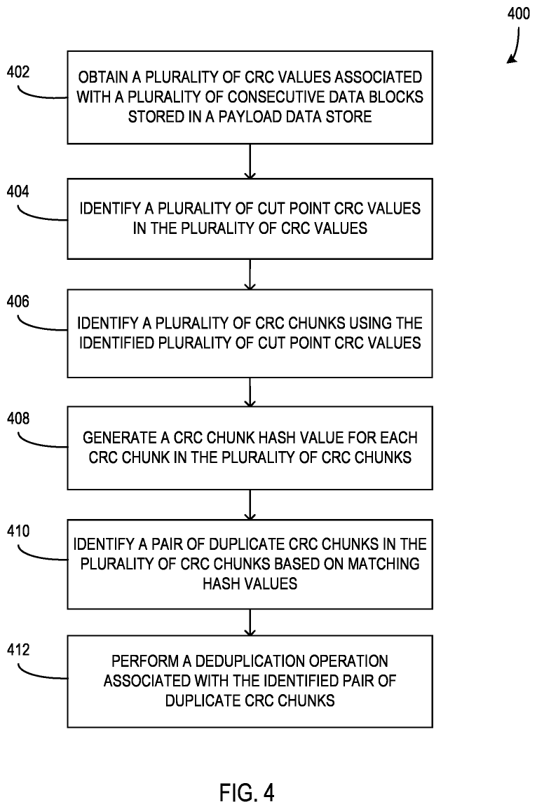

FIG. 4 is a flowchart illustrating an example method 400 of identifying duplicate CRC chunks (e.g., CRC chunks 229) and performing deduplication operations (e.g., deduplication operations 232) based on the identified duplicate CRC chunks. In some examples, the method 400 is executed or otherwise performed in a system such as systems 1 and/or 2 of FIGS. 1 and/or 2, respectively.

At 402, a plurality of CRC values is obtained that are associated with a plurality of consecutive data blocks stored in a payload data store. In some examples, the CRC values are obtained from a metadata data store such as metadata data store 214 and/or from a metadata storage structure such as an address map 219 as described herein. Further, in some examples, the CRC values are obtained in an order that reflects the logical order of the data blocks with which the CRC values are associated. For example, the obtained CRC values include CRC values associated with a group of logically consecutive data blocks that make up a logical data object and the CRC values associated with that group of data blocks are ordered in the same manner (e.g., the first CRC value is associated with the first data block, the second CRC value is associated with the second block, etc.).

At 404, a plurality of cut point CRC values are identified in the plurality of CRC values. In some examples, cut point CRC values are identified and/or CRC values are assigned to be cut point CRC values based on a cut point indicator. Each CRC value that includes a feature or pattern that is the cut point indicator or otherwise matches the cut point indicator is identified as a cut point CRC value. For example, the cut point indicator is a four-bit pattern of all zeroes that is compared to the four least significant bits of each CRC value. CRC values that have all zeroes in the four least significant bits are identified as cut point CRC values because they include the pattern of all zeroes in the four least significant bits. Additionally, or alternatively, for each CRC value, a chunk size count value is calculated or otherwise determined. The chunk size count value represents a chunk size of a CRC chunk including the previous subset of CRC values if the current CRC value is identified as a cut point CRC value. In some examples, the chunk size count value is calculated by counting the quantity of CRC values that have been evaluated since the first CRC value was evaluated or since the last cut point CRC value was identified, whichever occurred more recently. The chunk size count value is compared to a maximum chunk size value (e.g., maximum chunk size 226) and, if the chunk size count value meets or exceeds the maximum chunk size value, the current CRC value is identified as a cut point CRC value.

At 406, a plurality of CRC chunks is identified using the identified plurality of cut point CRC values. In some examples, a CRC chunk is identified as the group of CRC values between two cut point CRC values, inclusive of one of the cut point CRC values (e.g., see FIG. 3 where the cut point CRC values at the beginning of CRC chunks are included in the CRC chunks and the cut point CRC values at the end of CRC chunks are included as part of the next CRC chunks). Further, in some examples, CRC chunks are identified by a starting CRC value, an ending CRC value, and/or a quantity of CRC values contained in the CRC chunk. Additionally, or alternatively, the CRC chunks are identified using identifiers or other indicators of the CRC values that associate the CRC values with data blocks (e.g., a data block with an identifier of ‘A’ is associated with a CRC value with an identifier of ‘A’).

At 408, a CRC chunk hash value is generated for each CRC chunk in the plurality of CRC chunks. In some examples, a hash function is used with the CRC values of the CRC chunk as input to generate an associated hash value. The hash values are stored in a table of hash values or another type of data structure. Additionally, or alternatively, in some examples, the generated hash values are compared to other existing hash values in the hash value data structure after being generated to determine whether a duplicate hash value is already present in the hash value data structure. Alternatively, in some examples, all the hash values for the CRC chunks are generated and then compared with each other after the generation thereof.

At 410, a pair of duplicate CRC chunks are identified in the plurality of CRC chunks based on matching hash values and, at 412, a deduplication operation associated with the identified pair of duplicate CRC chunks is performed. In some examples, the deduplication operation includes identifying groups of data blocks associated with each of the duplicate CRC chunks. Cryptographic hash values are generated for each of the identified groups of data blocks and compared. If the cryptographic hash values of the groups of data blocks match, the deduplication operation is completed as described herein. Additionally, or alternatively, in some examples, the deduplication operation includes identifying those groups of data blocks associated with the duplicate CRC chunks, updating an address map of metadata to redirect references from the first group of data blocks to the second group of data blocks, and causing the first group of data blocks to be removed from the payload data store.

It should be understood that, in some examples, the method 500 includes receiving a write instruction associated with a plurality of data blocks and then computing a CRC value for each data block in the plurality of data blocks. The computed CRC values are stored in a metadata data store associated with the payload data store and the plurality of data blocks are stored in the payload data store. Further, the generated CRC values are available to be used for a variety of purposes, such as error checking, in addition to their use during the chunk deduplication processes described herein.

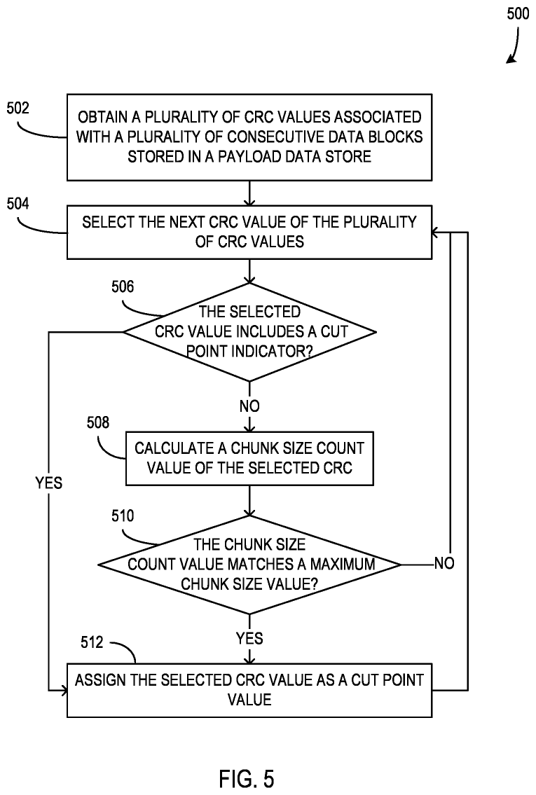

FIG. 5 is a flowchart illustrating an example method 500 for identifying cut point CRC values (e.g., cut point CRC values 228) in a plurality of CRC values (e.g., CRC batch 222). In some examples, the method 500 is executed or otherwise performed in a system such as systems 1 and/or 2 of FIGS. 1 and/or 2, respectively. Further, in some examples, the method 500 is performed as part of at least 404 of method 400 of FIG. 4.

At 502, a plurality of CRC values is obtained that are associated with a plurality of consecutive data blocks stored in a payload data store. At 504, the next CRC value of the plurality of CRC values is selected. If it is the first time 504 is performed, the first CRC value of the plurality of CRC values is selected as the “next CRC value”.

At 506, if the selected CRC value includes a cut point indicator (e.g., cut point indicator 224), the process proceeds to 512 to be assigned or otherwise identified as a cut point value. Alternatively, if the selected CRC value does not include a cut point indicator, the process proceeds to 508. In some examples, the cut point indicator is a feature or pattern that is present in some CRC values, such as the series of zero bits as described herein.

At 508, a chunk size count value of the selected CRC value is calculated. In some examples, the chunk size count value is a value that is maintained and incremented for each CRC value that is evaluated and then reset to zero when a CRC value is assigned or otherwise identified as a cut point CRC value. Thus, the chunk size count value for the selected CRC value is calculated during the performance of the method 500 over time. Alternatively, the chunk size count value is calculated for the selected CRC value by identifying the first CRC value of the plurality of CRC values or the last identified cut point CRC value, whichever was evaluated more recently. Then, the quantity of CRC values between this identified CRC value and the selected CRC value is used as the chunk size count value.

At 510, if the chunk size count value of the selected CRC value matches a defined maximum chunk size (e.g., maximum chunk size 226), the process proceeds to 512. Alternatively, if the chunk size count value of the selected CRC value does not match the defined maximum chunk size, the process returns to 504 to select the next CRC value for evaluation.

At 512, the selected CRC value is assigned as a cut point CRC value for use in identifying CRC chunks of the plurality of CRC values as described herein. Thus, a CRC value can be assigned as a cut point CRC value based on the presence of a cut point indicator therein or based on the chunk size count value matching the maximum chunk size value during evaluation of the CRC value.

### Exemplary Operating Environment

Aspects of the disclosure are operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, identifying cut points and associated data chunks and then performing deduplication operations on those data chunks as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or carphones), network PCs, minicomputers, mainframe computers, distributed computing environments that include any of the above systems or devices, and the like. In general, aspects of the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: a processor; and a memory comprising computer program code, the memory and the computer program code configured to cause the processor to: obtain a plurality of cyclic redundance check (CRC) values associated with a plurality of consecutive data blocks stored in a payload data store; identify a plurality of cut point CRC values in the plurality of CRC values; identify a plurality of CRC chunks using the identified plurality of cut point CRC values, wherein each CRC chunk of the plurality of CRC chunks is bounded by two consecutive cut point CRC values of the plurality of cut point CRC values; generate a CRC chunk hash value for each CRC chunk in the plurality of CRC chunks; identify a pair of duplicate CRC chunks in the plurality of CRC chunks, wherein each CRC chunk of the pair of duplicate CRC chunks is associated with matching generated CRC chunk hash values; and perform a deduplication operation associated with the identified pair of duplicate CRC chunks.

An example computerized method comprises: obtaining a plurality of cyclic redundance check (CRC) values associated with a plurality of consecutive data blocks stored in a payload data store; identifying a plurality of cut point CRC values in the plurality of CRC values; identifying a plurality of CRC chunks using the identified plurality of cut point CRC values, wherein each CRC chunk of the plurality of CRC chunks is bounded by two consecutive cut point CRC values of the plurality of cut point CRC values; generating a CRC chunk hash value for each CRC chunk in the plurality of CRC chunks; identifying a pair of duplicate CRC chunks in the plurality of CRC chunks, wherein each CRC chunk of the pair of duplicate CRC chunks is associated with matching generated CRC chunk hash values; and performing a deduplication operation associated with the identified pair of duplicate CRC chunks.

One or more computer storage media have computer-executable instructions that, upon execution by a processor, cause the processor to at least: obtain a plurality of cyclic redundance check (CRC) values associated with a plurality of consecutive data blocks stored in a payload data store; identify a plurality of cut point CRC values in the plurality of CRC values; identify a plurality of CRC chunks using the identified plurality of cut point CRC values, wherein each CRC chunk of the plurality of CRC chunks is bounded by two consecutive cut point CRC values of the plurality of cut point CRC values; generate a CRC chunk hash value for each CRC chunk in the plurality of CRC chunks; identify a pair of duplicate CRC chunks in the plurality of CRC chunks, wherein each CRC chunk of the pair of duplicate CRC chunks is associated with matching generated CRC chunk hash values; and perform a deduplication operation associated with the identified pair of duplicate CRC chunks.

Alternatively, or in addition to the other examples described herein, examples include any combination of the following:
wherein identifying the plurality of cut point CRC values in the plurality of CRC values includes: for each CRC value of the plurality of CRC values, evaluating the CRC value with respect to a cut point indicator in sequential order, the evaluation including: determining whether the CRC value includes a feature associated with the cut point indicator; and identifying the evaluated CRC value as a cut point CRC value based determining the CRC value includes the feature associated with the cut point indicator.
wherein evaluating the CRC value with respect to the cut point indicator in sequential order further includes: determining a chunk size count value of the CRC value that indicates a quantity of CRC values that have been evaluated since a last cut point CRC value was identified; determining whether the chunk size count value that equals a maximum chunk size value; and identifying the CRC value as a cut point CRC value based on the determined chunk size count value.
wherein the cut point indicator is a four-bit value that is compared to the last four bits of each CRC value during the evaluation of each CRC value.
further comprising: receiving a write instruction associated with a plurality of data blocks; computing a CRC value for each data block in the plurality of data blocks; storing the computed CRC values in a metadata data store associated with the payload data store; and storing the plurality of data blocks in the payload data store.
wherein the deduplication operation includes: identifying a first group of data blocks associated with a first CRC chunk of the pair of duplicate CRC chunks; identifying a second group of data blocks associated with a second CRC chunk of the pair of duplicate CRC chunks; generating a first cryptographic hash value of the first group of data blocks; generating a second cryptographic hash value of the second group of data blocks; determining that the first cryptographic hash value and second cryptographic hash value match; and completing the deduplication operation based on determining that the first cryptographic hash value and second cryptographic hash value match.
wherein the deduplication operation includes: identifying a first group of data blocks associated with a first CRC chunk of the pair of duplicate CRC chunks; identifying a second group of data blocks associated with a second CRC chunk of the pair of duplicate CRC chunks; updating an address map in a metadata data store associated with the payload data store to redirect references from the first group of data blocks to the second group of data blocks; and causing the first group of data blocks to be removed from the payload data store.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining a plurality of cyclic redundance check (CRC) values associated with a plurality of consecutive data blocks stored in a payload data store; exemplary means for identifying a plurality of cut point CRC values in the plurality of CRC values; exemplary means for identifying a plurality of CRC chunks using the identified plurality of cut point CRC values, wherein each CRC chunk of the plurality of CRC chunks is bounded by two consecutive cut point CRC values of the plurality of cut point CRC values; exemplary means for generating a CRC chunk hash value for each CRC chunk in the plurality of CRC chunks; exemplary means for identifying a pair of duplicate CRC chunks in the plurality of CRC chunks, wherein each CRC chunk of the pair of duplicate CRC chunks is associated with matching generated CRC chunk hash values; and exemplary means for performing a deduplication operation associated with the identified pair of duplicate CRC chunks.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a chunk deduplicator obtaining, from a metadata data store, a plurality of cyclic redundance check (CRC) values associated with a plurality of consecutive data blocks stored in a payload data store;
a cut point identifier of the chunk deduplicator identifying a plurality of cut point CRC values in the plurality of CRC values;
the chunk deduplicator identifying a plurality of CRC chunks using the identified plurality of cut point CRC values, wherein each CRC chunk of the plurality of CRC chunks is bounded by two consecutive cut point CRC values of the plurality of cut point CRC values;
a hash value generator of the chunk deduplicator generating a CRC chunk hash value for each CRC chunk in the plurality of CRC chunks;
a duplicate chunk identifier of the chunk deduplicator identifying a pair of duplicate CRC chunks in the plurality of CRC chunks, wherein each CRC chunk of the pair of duplicate CRC chunks is associated with matching generated CRC chunk hash values; and
the chunk deduplicator performing a deduplication operation on data blocks in the payload data store associated with the identified pair of duplicate CRC chunks.

2. The system of claim 1, wherein identifying the plurality of cut point CRC values in the plurality of CRC values includes:
for each CRC value of the plurality of CRC values, evaluating the CRC value with respect to a cut point indicator in sequential order, the evaluation including:
determining whether the CRC value includes a feature associated with the cut point indicator; and
identifying the evaluated CRC value as a cut point CRC value based on determining that the CRC value includes the feature associated with the cut point indicator.

3. The system of claim 2, wherein evaluating the CRC value with respect to the cut point indicator in sequential order further includes:
determining a chunk size count value of the CRC value that indicates a quantity of CRC values that have been evaluated since a last cut point CRC value was identified;
determining that the chunk size count value equals a maximum chunk size value; and
identifying the CRC value as a cut point CRC value based on the determined chunk size count value.

4. The system of claim 2, wherein the cut point indicator is a four-bit value that is compared to the last four bits of each CRC value during the evaluation of each CRC value.

5. The system of claim 1, further comprising:
an instruction processing module receiving a write instruction associated with a plurality of data blocks;
the instruction processing module computing a CRC value for each data block in the plurality of data blocks;
the instruction processing module storing the computed CRC values in a metadata data store associated with the payload data store; and
the instruction processing module storing the plurality of data blocks in the payload data store.

6. The system of claim 1, wherein the deduplication operation includes:
identifying a first group of data blocks associated with a first CRC chunk of the pair of duplicate CRC chunks;
identifying a second group of data blocks associated with a second CRC chunk of the pair of duplicate CRC chunks;
generating a first cryptographic hash value of the first group of data blocks;
generating a second cryptographic hash value of the second group of data blocks;
determining that the first cryptographic hash value and second cryptographic hash value match; and
completing the deduplication operation based on determining that the first cryptographic hash value and second cryptographic hash value match.

7. The system of claim 1, wherein the deduplication operation includes:
identifying a first group of data blocks associated with a first CRC chunk of the pair of duplicate CRC chunks;
identifying a second group of data blocks associated with a second CRC chunk of the pair of duplicate CRC chunks;
updating an address map in a metadata data store associated with the payload data store to redirect references from the first group of data blocks to the second group of data blocks; and
causing the first group of data blocks to be removed from the payload data store.

8. A computerized method comprising:
obtaining a plurality of cyclic redundance check (CRC) values associated with a plurality of consecutive data blocks stored in a payload data store;
identifying a plurality of cut point CRC values in the plurality of CRC values;
identifying a plurality of CRC chunks using the identified plurality of cut point CRC values, wherein each CRC chunk of the plurality of CRC chunks is bounded by two consecutive cut point CRC values of the plurality of cut point CRC values;
generating a CRC chunk hash value for each CRC chunk in the plurality of CRC chunks;
identifying a pair of duplicate CRC chunks in the plurality of CRC chunks, wherein each CRC chunk of the pair of duplicate CRC chunks is associated with matching generated CRC chunk hash values; and
performing a deduplication operation associated with the identified pair of duplicate CRC chunks.

9. The computerized method of claim 8, wherein identifying the plurality of cut point CRC values in the plurality of CRC values includes:
for each CRC value of the plurality of CRC values, evaluating the CRC value with respect to a cut point indicator in sequential order, the evaluation including:
determining whether the CRC value includes a feature associated with the cut point indicator; and
identifying the evaluated CRC value as a cut point CRC value based on determining that the CRC value includes the feature associated with the cut point indicator.

10. The computerized method of claim 9, wherein evaluating the CRC value with respect to the cut point indicator in sequential order further includes:
determining a chunk size count value of the CRC value that indicates a quantity of CRC values that have been evaluated since a last cut point CRC value was identified;
determining that the chunk size count value equals a maximum chunk size value; and
identifying the CRC value as a cut point CRC value based on the determined chunk size count value.

11. The computerized method of claim 9, wherein the cut point indicator is a four-bit value that is compared to the last four bits of each CRC value during the evaluation of each CRC value.

12. The computerized method of claim 8, further comprising:
receiving a write instruction associated with a plurality of data blocks;
computing a CRC value for each data block in the plurality of data blocks;
storing the computed CRC values in a metadata data store associated with the payload data store; and
storing the plurality of data blocks in the payload data store.

13. The computerized method of claim 8, wherein the deduplication operation includes:
identifying a first group of data blocks associated with a first CRC chunk of the pair of duplicate CRC chunks;
identifying a second group of data blocks associated with a second CRC chunk of the pair of duplicate CRC chunks;
generating a first cryptographic hash value of the first group of data blocks;
generating a second cryptographic hash value of the second group of data blocks;
determining that the first cryptographic hash value and second cryptographic hash value match; and
completing the deduplication operation based on determining that the first cryptographic hash value and second cryptographic hash value match.

14. The computerized method of claim 8, wherein the deduplication operation includes:
identifying a first group of data blocks associated with a first CRC chunk of the pair of duplicate CRC chunks;
identifying a second group of data blocks associated with a second CRC chunk of the pair of duplicate CRC chunks;
updating an address map in a metadata data store associated with the payload data store to redirect references from the first group of data blocks to the second group of data blocks; and
causing the first group of data blocks to be removed from the payload data store.

15. One or more computer storage media having computer-executable instructions that, upon execution by a processor, cause the processor to at least:
obtain a plurality of error checking values associated with a plurality of consecutive data blocks stored in a payload data store;
identify a plurality of cut point error checking values in the plurality of error checking values;
identify a plurality of chunks using the identified plurality of cut point error checking values, wherein each chunk of the plurality of chunks is bounded by two consecutive cut point error checking values of the plurality of cut point error checking values;
generate a chunk hash value for each chunk in the plurality of chunks;
identify a pair of duplicate chunks in the plurality of chunks, wherein each chunk of the pair of duplicate chunks is associated with matching generated chunk hash values; and
perform a deduplication operation associated with the identified pair of duplicate chunks.

16. The computer storage media of claim 15, wherein identifying the plurality of cut point error checking values in the plurality of error checking values includes:
for each error checking value of the plurality of error checking values, evaluating the error checking value with respect to a cut point indicator in sequential order, the evaluation including:
determining whether the error checking value includes a feature associated with the cut point indicator; and
identifying the evaluated error checking value as a cut point error checking value based on determining that the error checking value includes the feature associated with the cut point indicator.

17. The computer storage media of claim 16, wherein evaluating the error checking value with respect to the cut point indicator in sequential order further includes:
determining a chunk size count value of the error checking value that indicates a quantity of error checking values that have been evaluated since a last cut point error checking value was identified;
determining that the chunk size count value equals a maximum chunk size value; and
identifying the error checking value as a cut point error checking value based on the determined chunk size count value.

18. The computer storage media of claim 16, wherein the cut point indicator is a four-bit value that is compared to the last four bits of each error checking value during the evaluation of each error checking value.

19. The computer storage media of claim 15, wherein the computer-executable instructions, upon execution by a processor, further cause the processor to at least:
receive a write instruction associated with a plurality of data blocks;
compute an error checking value for each data block in the plurality of data blocks;
store the computed error checking values in a metadata data store associated with the payload data store; and
store the plurality of data blocks in the payload data store.

20. The computer storage media of claim 15, wherein the deduplication operation includes:
identifying a first group of data blocks associated with a first chunk of the pair of duplicate chunks;
identifying a second group of data blocks associated with a second chunk of the pair of duplicate chunks;
updating an address map in a metadata data store associated with the payload data store to redirect references from the first group of data blocks to the second group of data blocks; and
causing the first group of data blocks to be removed from the payload data store.
